(19) United States
(12) Patent Application Publication
(10) Pub. No.: US 2020/0192764 A1
(43) Pub. Date: Jun. 18, 2020

(54) Method for Protecting Connected Car Service Information

(71) Applicants: Hyundai Motor Company, Seoul (KR); Kia Motors Corporation, Seoul (KR)

(72) Inventor: Jae Yoon Ko, Gyeonggi-do (KR)

(73) Assignees: Hyundai Motor Company, Seoul (KR); Kia Motors Corporation, Seoul (KR)

(21) Appl. No.: 16/414,960

(22) Filed: May 17, 2019

(30) Foreign Application Priority Data
Dec. 12, 2018 (KR) 10-2018-0159726

(51) Int. Cl. G06F 11/14; G07C 5/00; H04L 29/06; G06F 21/62

(52) U.S. Cl. CPC G06F 11/1464; G07C 5/008; G06F 2201/84; H04L 63/0876; G06F 21/6245; G06F 11/1469

(57) ABSTRACT

A connected car service information protection method is used for backing up connected car service information stored in a connected car terminal onto a mobile terminal of a user in response to a request of the user. The method further enables restoring of the backup data stored in the user's mobile terminal to the connected car terminal. The connected car service information protection method includes establishing a communication connection with the mobile terminal by the connected car terminal, generating backup data for the connected car service information by the connected car terminal, and transmitting the backup data to the mobile terminal by the connected car terminal.

### CROSS-REFERENCE TO RELATED APPLICATION

This application claims the benefit of priority to Korean Patent Application No. 10-2018-0159726, filed in the Korean Intellectual Property Office on Dec. 12, 2018, the entire contents of which are incorporated herein by reference.

### TECHNICAL FIELD

The present disclosure relates to a method for protecting connected car service information.

### BACKGROUND

In recent years, connected cars have been increasingly studied and developed. The connected cars refer to cars that are outfitted with information and communication technology and are capable of providing interactive internet services, a mobile service, or the like.

A driver of a connected car may remotely turn on the ignition of the car or a heater inside the car and may receive various types of contents, such as weather, news, music, and the like, in real time.

The history of the connected car service provided to the driver includes information, such as the driver's taste or a travel path and travel time, through which personal propensities can be identified. Therefore, the driver may have difficulty in social life if the connected car service history is exposed to other people.

For example, when the driver lends the car to someone else or takes the car to a shop for repairs, service or usage history information stored in a connected car terminal may be exposed to other people. Accordingly, a way for protecting the service or usage history information is required.

### SUMMARY

The present disclosure has been made to solve the above-mentioned problems occurring in the prior art while advantages achieved by the prior art are maintained intact.

An aspect of the present disclosure provides a connected car service information protection method for backing up connected car service information stored in a connected car terminal onto a mobile terminal of a user in response to a request of the user and restoring the backup data stored in the user's mobile terminal to the connected car terminal, thereby preventing the user's connected car service information from being exposed to other people and enabling the backed up personal information to be utilized when a connected car service is provided later.

The technical problems to be solved by the present disclosure are not limited to the aforementioned problems, and any other technical problems not mentioned herein will be clearly understood from the following description by those skilled in the art to which the present disclosure pertains. Also, it will be easily understood that the aspects and advantages of the present disclosure can be accomplished by the means set forth in the appended claims and combinations thereof.

According to an aspect of the present disclosure, a method for protecting connected car service information includes establishing a communication connection with a mobile terminal by a connected car terminal, generating backup data for the connected car service information by the connected car terminal, and transmitting the generated backup data over the established communication connection to the mobile terminal by the connected car terminal.

The establishing of the communication connection with the mobile terminal by the connected car terminal may be done when the connected car terminal receives a reset request for a connected car service from a user.

The method may further include removing the connected car service information by the connected car terminal. The removing of the connected car service information by the connected car terminal may be performed after the transmitting of the generated backup data to the mobile terminal by the connected car terminal.

The method may further include restoring backup data received from the mobile terminal by the connected car terminal. The restoring of the backup data received from the mobile terminal by the connected car terminal may be performed after the removing of the connected car service information by the connected car terminal.

The restoring of the backup data received from the mobile terminal by the connected car terminal may include establishing of another communication connection with the mobile terminal and determining whether the mobile terminal is a mobile terminal specified in advance, based on an authentication result of the mobile terminal that is received from a telematics server.

The transmitting of the generated backup data to the mobile terminal by the connected car terminal may include determining whether the mobile terminal is a mobile terminal specified in advance, based on an authentication result of the mobile terminal that is received from a telematics server.

The connected car service information may include at least one of connected car service history information, personal information, a point of interest (POI), or search data.

According to another aspect of the present disclosure, a method for protecting connected car service information includes generating backup data for the connected car service information by a connected car terminal and transmitting the backup data to a mobile terminal via a telematics server by the connected car terminal.

The generating of the backup data for the connected car service information by the connected car terminal may be performed when the connected car terminal receives a reset request for a connected car service from a user.

The method may further include removing the connected car service information by the connected car terminal. The removing of the connected car service information by the connected car terminal may be performed after the transmitting of the backup data to the mobile terminal via the telematics server by the connected car terminal.

The method may further include restoring backup data received from the mobile terminal via the telematics server by the connected car terminal. The restoring of the backup data received from the mobile terminal via the telematics server by the connected car terminal may be performed after the removing of the connected car service information by the connected car terminal.

The restoring of the backup data received from the mobile terminal via the telematics server by the connected car terminal may include accessing the telematics server and performing authentication by the mobile terminal and transmitting backup data stored in the mobile terminal, to the connected car terminal via the telematics server by the mobile terminal.

The restoring of the backup data received from the mobile terminal via the telematics server by the connected car terminal may further include informing the user of the receipt of the backup data by the connected car terminal.

The transmitting of the backup data to the mobile terminal via the telematics server by the connected car terminal may include performing authentication of the mobile terminal by the telematics server, searching for found backup data corresponding to the mobile terminal by the telematics server, and transferring the found backup data to the mobile terminal.

The connected car service information may include at least one of connected car service history information, personal information, a point of interest (POI), or search data.

According to another aspect of the present disclosure, a method for protecting connected car service information includes establishing a communication connection with a mobile terminal by a connected car terminal in response to a reset request for a connected car service, generating and transmitting over the established communication connection backup data for the connected car service information to the mobile terminal by the connected car terminal, and removing the connected car service information by the connected car terminal.

The method may further include receiving backup data from the mobile terminal by the connected car terminal and restoring the received backup data by the connected car terminal. The receiving of the backup data from the mobile terminal by the connected car terminal may be performed after the removing of the connected car service information by the connected car terminal.

The restoring of the received backup data by the connected car terminal may include establishing another communication connection with the mobile terminal and determining whether the mobile terminal is a mobile terminal specified in advance, based on an authentication result of the mobile terminal that is received from a telematics server.

The generating and transmitting of the backup data for the connected car service information to the mobile terminal by the connected car terminal may include determining whether the mobile terminal is a mobile terminal specified in advance, based on an authentication result of the mobile terminal that is received from a telematics server.

The connected car service information may include at least one of connected car service history information, personal information, a point of interest (POI), or search data.

### BRIEF DESCRIPTION OF THE DRAWINGS

The above and other objects, features and advantages of the present disclosure will be more apparent from the following detailed description taken in conjunction with the accompanying drawings:

FIG. 1 is an exemplary view illustrating a configuration of a connected car service system to which the present disclosure is applied;

FIG. 2 is a sequence diagram illustrating a connected car service information protection method according to a first embodiment of the present disclosure;

FIG. 3 is a sequence diagram illustrating a connected car service information protection method according to a second embodiment of the present disclosure;

FIG. 4 is a sequence diagram illustrating a backup data recovery process that may be added to the connected car service information protection method according to the first embodiment of the present disclosure;

FIG. 5 is a sequence diagram illustrating a backup data recovery process that may be added to the connected car service information protection method according to the second embodiment of the present disclosure; and

FIG. 6 is a block diagram illustrating a computing system for executing the connected car service information protection methods according to the embodiments of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence, or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

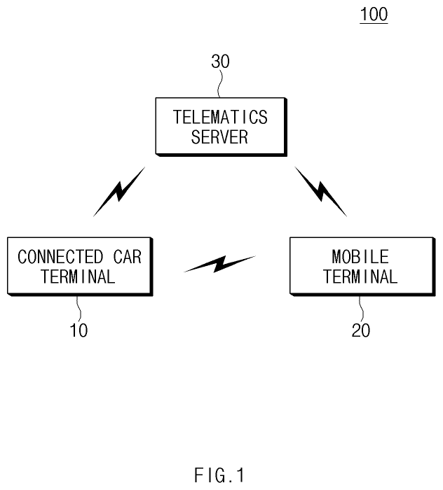

FIG. 1 is an exemplary view illustrating a configuration of a connected car service system 100 to which the present disclosure pertains.

As illustrated in FIG. 1, the connected car service system 100, to which the present disclosure pertains, may include a connected car terminal 10, a mobile terminal 20, and a telematics server 30. The components may be integrated together in accordance with manners of carrying out the connected car service system 100 to which the present disclosure pertains. In addition, some of the components may be omitted in accordance with manners of carrying out the present disclosure.

The connected car terminal 10 is mounted in a vehicle and has a user interface function, a communication function, and a control function. The connected car terminal 10 serves to provide a connected car service to a user.

The connected car terminal 10 may generate backup data including connected car service or usage information in response to a reset request from the user. In this case, the connected car service information may include connected car service or usage history information representing a history of manners in which the user used the connected car service, various types of personal information (e.g., a telephone number list, a name, an address, an account number, and the like) input by the user, a point of interest (POI) set by the user during the use of the connected car service, search data, and the like.

The connected car terminal 10 may read backup data from the mobile terminal 20 and may recover the backup data.

The connected car terminal 10 may communicate with the mobile terminal 20 via short range wireless communication or wireless Internet. Here, the short range wireless communication may include Bluetooth™, radio frequency identification (RFID), infrared data association (IrDA), ultra wideband (UWB), ZigBee, near field communication (NFC), wireless universal serial bus (wireless USB), or the like. The wireless Internet may include wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), or the like.

Also, the connected car terminal 10 may communicate with the telematics server 30 via mobile communication or wireless Internet. Here, the mobile communication may include global system for mobile communication (GSM), code division multi access (CDMA), code division multi access 2000 (CDMA 2000), enhanced voice-data optimized or enhanced voice-data only (EV-DO), wideband CDMA (WCDMA), high speed downlink packet access (HSDPA), high speed uplink packet access (HSUPA), long team evolution (LTE), long term evolution-advanced (LTE-A), or the like.

The mobile terminal 20 is a terminal capable of short range wireless communication, mobile communication, and/or wireless Internet access. The mobile terminal 20 may include a smartphone, a portable notebook computer, a tablet PC, or the like.

The mobile terminal 20 may store backup data received from the connected car terminal 10 and may transmit the stored backup data to the connected car terminal 10.

The mobile terminal 20 may communicate with the connected car terminal 10 via short range wireless communication or wireless Internet.

Also, the mobile terminal 20 may communicate with the telematics server 30 via mobile communication or wireless Internet.

The telematics server 30 receives the registration of the connected car terminal 10 and the mobile terminal 20 in advance. Of course, the user of the mobile terminal 20 can have a subscription to a telematics service.

The telematics server 30 may authenticate the user of the mobile terminal 20 and may transmit the authentication result to the connected car terminal 10. In this case, the authentication scheme may be a scheme to enter an ID and a password. However, the authentication scheme is not limited thereto.

The telematics server 30 may receive backup data from the connected car terminal 10 and may transmit the backup data to the mobile terminal 20 of the user in response to a request of the user.

The telematics server 30 may transfer backup data from the mobile terminal 20 of the user to the connected car terminal 10.

The telematics server 30 may serve to authenticate the user of the mobile terminal 20 and relay backup data between the connected car terminal 10 and the mobile terminal 20 of the user.

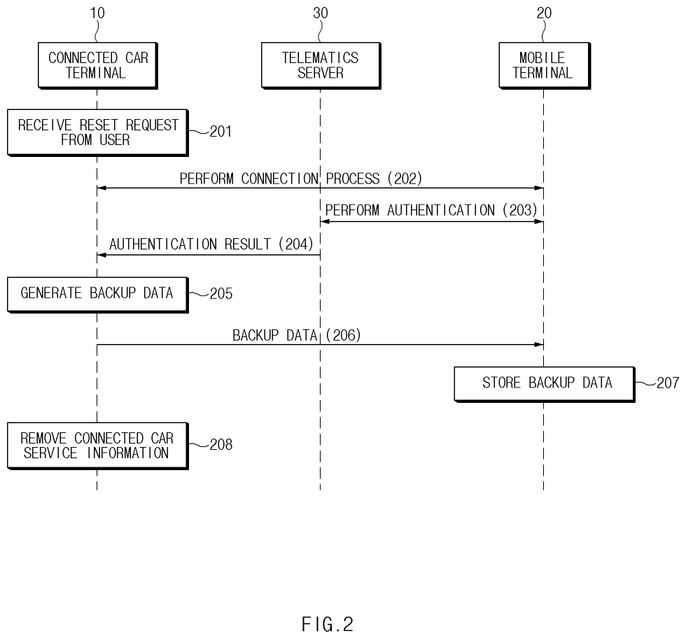

FIG. 2 is a sequence diagram illustrating a connected car service information protection method according to a first embodiment of the present disclosure.

When the connected car terminal 10 receives a reset request for a connected car service from the user (201), the connected car terminal 10 performs a connection process with the mobile terminal 20 of the user (202) (e.g., in response to completing step 201). In this case, information about the mobile terminal 20 of the user is already stored in the connected car terminal 10. Here, the connection process includes a discovery process and a setting process for communication between the connected car terminal 10 and the mobile terminal 20.

The mobile terminal 20 connected with the connected car terminal 10 accesses the telematics server 30 and performs authentication (203). Step 203 may be performed in response to establishing a successful connection in step 202. In this case, the telematics server 30 may authenticate the mobile terminal 20, or may authenticate the user of the mobile terminal 20. Here, the authentication is performed to determine whether the mobile terminal 20 is allowed to receive backup data stored in the connected car terminal 10. Accordingly, when the mobile terminal 20 is authenticated normally, the telematics server 30 determines that the mobile terminal 20 is allowed to receive the backup data stored in the connected car terminal 10.

The telematics server 30 transmits the authentication result of the mobile terminal 20 to the connected car terminal 10 (204) (e.g., in response to completing step 203).

The connected car terminal 10 generates backup data using connected car service or usage information that includes connected car service or usage history information, personal information, a point of interest (POI), search data, and the like (205) (e.g., in response to completing step 204).

The connected car terminal 10 transmits the backup data to the mobile terminal 20 (206) (e.g., in response to completing steps 204/205).

The mobile terminal 20 stores the received backup data (207).

The connected car terminal 10 removes the connected car service information (208) (e.g., in response to completing step 207). For example, the connected car terminal 10 removes the connected car service information from its local memory within the car or vehicle.

The first embodiment illustrates the process in which the mobile terminal 20 directly receives and stores the backup data from the connected car terminal 10.

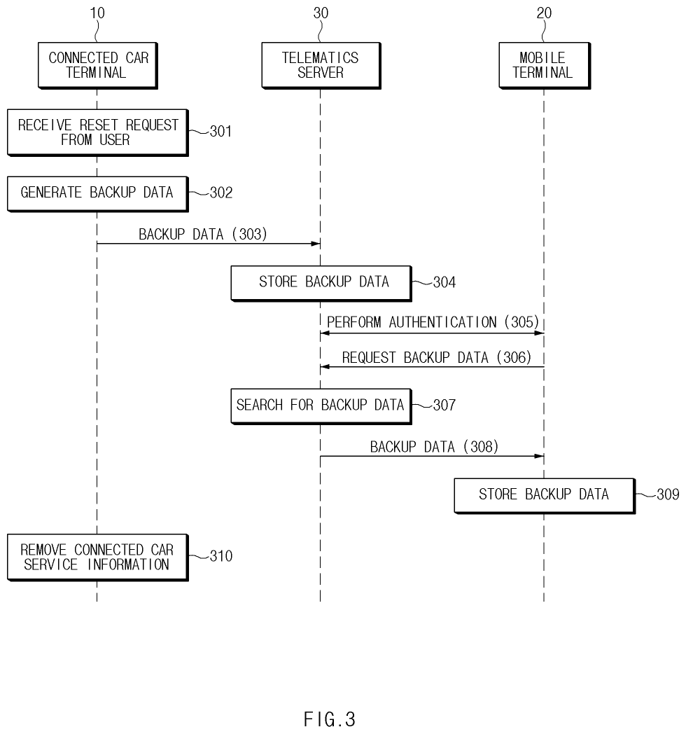

FIG. 3 is a sequence diagram illustrating a connected car service information protection method according to a second embodiment of the present disclosure.

When the connected car terminal 10 receives a reset request for a connected car service from the user (301), the connected car terminal 10 generates backup data using connected car service or usage information that includes connected car service or usage history information, personal information, a point of interest (POI), search data, and the like (302) (e.g., in response to completing step 301).

The connected car terminal 10 transmits the backup data to the telematics server 30 (303) (e.g., in response to completing step 302).

The telematics server 30 stores the received backup data (304) (e.g., in response to completing step 303).

The telematics server 30 performs authentication in response to an authentication request from the mobile terminal 20 (305) (e.g., in response to completing step 304). In this case, the telematics server 30 may authenticate the mobile terminal 20, or may authenticate the user of the mobile terminal 20. Here, the authentication is performed to determine whether the mobile terminal 20 is allowed to receive the backup data stored in the telematics server 30. Accordingly, when the mobile terminal 20 is authenticated normally, the telematics server 30 determines that the mobile terminal 20 is allowed to receive the backup data.

The mobile terminal 20 requests the backup data from the telematics server 30 (306) (e.g., in response to completing step 305).

The telematics server 30 searches for the backup data corresponding to the mobile terminal 20 among backup data stored in the telematics server 30 and transmits the found backup data to the mobile terminal 20 (307 and 308) (e.g., in response to completing step 306). In this case, the backup data is backup data generated by the connected car terminal 10 mounted in a vehicle that is specified by the user of the mobile terminal 20.

The mobile terminal 20 stores the received backup data (309) (e.g., in response to completing step 308).

The connected car terminal 10 removes the connected car service information (310). The connected car terminal 10 may remove the connected car service information (310) in response to the data being stored in the telematics server 30 (e.g., after step 304), or in response to the data being stored in the mobile terminal 20 (e.g., after step 309).

The second embodiment illustrates the process in which the mobile terminal 20 receives and stores the backup data from the connected car terminal 10 via the telematics server 30 when the mobile terminal 20 is incapable of accessing the connected car terminal 10.

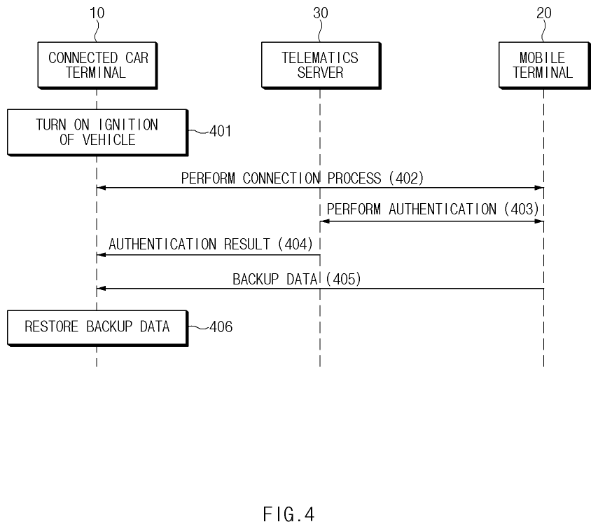

FIG. 4 is a sequence diagram illustrating a backup data recovery process that may be added to the connected car service or usage information protection method according to the first embodiment of the present disclosure.

When the ignition of the vehicle is turned on (401), the connected car terminal 10 performs a connection process with the mobile terminal 20 (402). In this case, the mobile terminal 20 is preferably located inside the vehicle.

The mobile terminal 20 accesses the telematics server 30 and performs an authentication process (403) (e.g., in response to completing step 402).

The telematics server 30 transmits the authentication result to the connected car terminal 10 (404) (e.g., in response to completing step 403). When the connected car terminal 10 receives an authentication result indicating that the mobile terminal 20 is authenticated normally, the connected car terminal 10 prepares to recover backup data.

The mobile terminal 20, which is authenticated normally, transmits backup data stored therein, to the connected car terminal 10 (405) (e.g., in response to completing steps 403/404).

The connected car terminal 10 recovers the received backup data (406) (e.g., in response to completing step 405).

The backup data recovery process is applicable when the connected car terminal 10 and the mobile terminal 20 are able to communicate with each other.

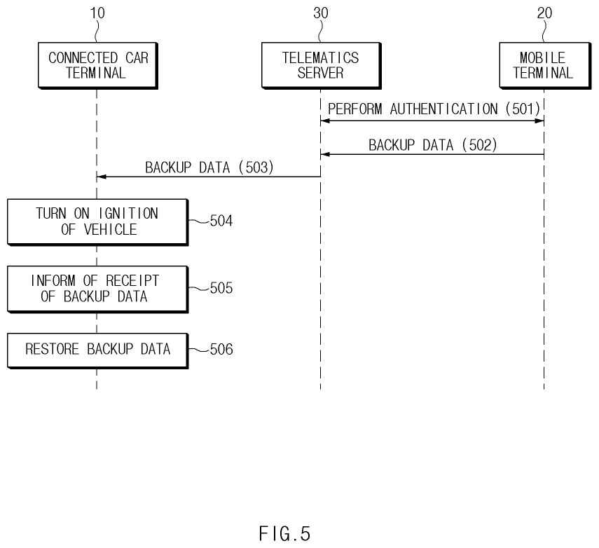

FIG. 5 is a sequence diagram illustrating a backup data recovery process that may be added to the connected car service information protection method according to the second embodiment of the present disclosure.

The mobile terminal 20 accesses the telematics server 30 and performs an authentication process (501).

The mobile terminal 20 that is authenticated normally transmits backup data stored therein, to the telematics server 30 (502) (e.g., in response to completing step 501).

The telematics server 30 transfers the backup data from the telematics server 30 to the connected car terminal 10 (503) (e.g., in response to completing step 502). In this case, the telematics server 30 transmits the backup data to the connected car terminal 10 that is previously specified by the user of the mobile terminal 20.

When the ignition of the vehicle is turned on (504) (e.g., following completion of step 503), the connected car terminal 10 outputs a guide sound or a guide message to inform the user that the backup data is received (505).

The connected car terminal 10 restores the received backup data when the user requests that the backup data is restored (506). Also, the connected car terminal 10 may restore the received backup data irrespective of the user's request (e.g., in response to completing steps 504/505).

The backup data recovery process is applicable when the connected car terminal 10 and the mobile terminal 20 are unable to communicate directly with each other.

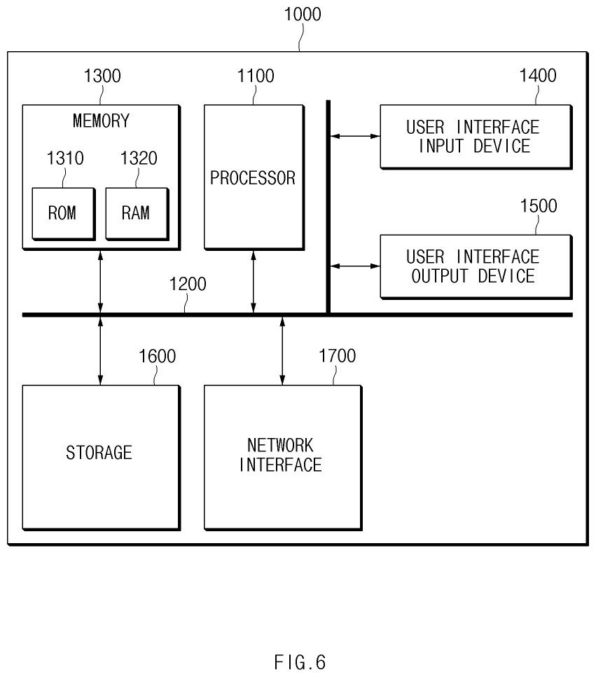

FIG. 6 is a block diagram illustrating a computing system 1000 for executing the connected car service information protection methods according to the embodiments of the present disclosure. The computing system 1000 may be used to implement the connected car terminal 10, the mobile terminal 20, and/or the telematics server 30.

Referring to FIG. 6, the connected car service information protection methods according to the embodiments of the present disclosure may be implemented through the computing system 1000. The computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the methods or the algorithms described in connection with the embodiments disclosed herein may be embodied directly in hardware or a software module executed by one or more processor(s) 1100, or in a combination thereof. The software module may reside on a storage medium (that is, the memory 1300 and/or the storage 1600) such as a RAM memory, a flash memory, a ROM memory, an EPROM memory, an EEPROM memory, a register, a hard disk, a solid state drive (SSD), a removable disk, or a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to the embodiments of the present disclosure, the connected car service information protection methods back up the connected car service information stored in the connected car terminal onto the mobile terminal of the user in response to the user's request and restore the backup data stored in the user's mobile terminal to the connected car terminal, thereby preventing the user's connected car service information from being exposed to other people and enabling the backed up personal information to be utilized when a connected car service is provided later.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A method for protecting connected car service information, the method comprising:
establishing a communication connection with a mobile terminal by a connected car terminal;
generating backup data for the connected car service information by the connected car terminal; and
transmitting the generated backup data over the established communication connection to the mobile terminal by the connected car terminal.

2. The method of claim 1, wherein the establishing of the communication connection with the mobile terminal by the connected car terminal is done when the connected car terminal receives a reset request for a connected car service from a user.

3. The method of claim 2, further comprising:
removing the connected car service information by the connected car terminal,
wherein the removing of the connected car service information by the connected car terminal is performed after the transmitting the generated backup data to the mobile terminal by the connected car terminal.

4. The method of claim 3, further comprising:
restoring backup data received from the mobile terminal by the connected car terminal,
wherein the restoring of the backup data received from the mobile terminal by the connected car terminal is performed after the removing of the connected car service information by the connected car terminal.

5. The method of claim 4, wherein the restoring of the backup data received from the mobile terminal by the connected car terminal includes:
determining whether the mobile terminal is a mobile terminal specified in advance, based on an authentication result of the mobile terminal that is received from a telematics server.

6. The method of claim 1, wherein the transmitting of the generated backup data to the mobile terminal by the connected car terminal includes:
determining whether the mobile terminal is a mobile terminal specified in advance, based on an authentication result of the mobile terminal that is received from a telematics server.

7. The method of claim 1, wherein the connected car service information includes at least one of connected car service history information, personal information, a point of interest (POI), or search data.

8. A method for protecting connected car service information, the method comprising:
generating backup data for the connected car service information by a connected car terminal; and
transmitting the backup data to a mobile terminal via a telematics server by the connected car terminal.

9. The method of claim 8, wherein the generating of the backup data for the connected car service information by the connected car terminal is performed when the connected car terminal receives a reset request for a connected car service from a user.

10. The method of claim 9, further comprising:
removing the connected car service information by the connected car terminal,
wherein the removing of the connected car service information by the connected car terminal is performed after the transmitting of the backup data to the mobile terminal via the telematics server by the connected car terminal.

11. The method of claim 10, further comprising:
restoring backup data received from the mobile terminal via the telematics server by the connected car terminal,
wherein the restoring of the backup data received from the mobile terminal via the telematics server by the connected car terminal is performed after the removing of the connected car service information by the connected car terminal.

12. The method of claim 11, wherein the restoring of the backup data received from the mobile terminal via the telematics server by the connected car terminal includes:
accessing the telematics server and performing authentication by the mobile terminal; and
transmitting backup data stored in the mobile terminal, to the connected car terminal via the telematics server by the mobile terminal.

13. The method of claim 12, wherein the restoring of the backup data received from the mobile terminal via the telematics server by the connected car terminal further includes:
informing the user of the receipt of the backup data by the connected car terminal.

14. The method of claim 8, wherein the transmitting of the backup data to the mobile terminal via the telematics server by the connected car terminal includes:
performing authentication of the mobile terminal by the telematics server;
searching for found backup data corresponding to the mobile terminal by the telematics server; and
transferring the found backup data to the mobile terminal.

15. The method of claim 8, wherein the connected car service information includes at least one of connected car service history information, personal information, a point of interest (POI), or search data.

16. A method for protecting connected car service information, the method comprising:
establishing a communication connection with a mobile terminal by a connected car terminal in response to a reset request for a connected car service;
generating and transmitting over the established communication connection backup data for the connected car service information to the mobile terminal by the connected car terminal; and
removing the connected car service information by the connected car terminal.

17. The method of claim 16, further comprising:
receiving backup data from the mobile terminal by the connected car terminal; and
restoring the received backup data by the connected car terminal,
wherein the receiving of the backup data from the mobile terminal by the connected car terminal is performed after the removing of the connected car service information by the connected car terminal.

18. The method of claim 17, wherein the restoring of the received backup data by the connected car terminal includes:
determining whether the mobile terminal is a mobile terminal specified in advance, based on an authentication result of the mobile terminal that is received from a telematics server.

19. The method of claim 16, wherein the generating and transmitting of the backup data for the connected car service information to the mobile terminal by the connected car terminal includes:
determining whether the mobile terminal is a mobile terminal specified in advance, based on an authentication result of the mobile terminal that is received from a telematics server.

20. The method of claim 16, wherein the connected car service information includes at least one of connected car service history information, personal information, a point of interest (POI), or search data.
